(19) United States
(12) Patent Application Publication
(10) Pub. No.: US 2003/0038267 A1
(43) Pub. Date: Feb. 27, 2003

(54) Valve handle

(76) Inventor: Donald Gross, Hanover, MD (US)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 09/938,770

(22) Filed: Aug. 24, 2001

(51) Int. Cl. F16K 5/00; F16K 31/60

(52) U.S. Cl. 251/293; 251/230

(57) ABSTRACT

An improved valve handle that has a proximal end attached to the valve and operable to actuate the valve, and a distal end that defines an opening therein. The opening is adapted to receive a handle extension. The handle extension is a standard rachet handle having a drive plug that is received in the opening. The ratchet drive of the handle extension is set in the proper position and the handle is placed in a desired orientation relative to the handle and taking into account the space available for the extension. The extension may be removed from the handle or may be stored in place by aligning the handle extension with the length of the handle.

### BACKGROUND OF THE INVENTION

1. Field of the Invention

The present invention is generally directed toward valve handles and, more particularly, toward an improved valve handle that readily permits extension of the handle in space-limited environments.

2. Description of Related Art

Many weeks or months may pass between the time when a valve is opened (or closed) and the next time it is moved to the closed (or opened) position. In these situations, it is not uncommon for the valve to “freeze”, which requires extra torque on the handle to break the valve free. When space is limited, such as in marine applications, it is often impossible or impractical to make the valve handle the length necessary to gain the required leverage or torque. Therefore, it is common for the worker to strike or hit the valve handle one or more times with a wrench or other tool in an attempt to free-up the valve. Naturally, this solution is not desirable, and is ordinarily used as a last resort.

Additionally, valves in marine applications are frequently installed in locations that are not readily and/or easily accessible due to their close proximity to engines, generators, and related equipment. A person wishing to actuate a valve handle may not be able to reach it, or may be able to reach it but not be able to achieve the full ninety-degree handle throw required to fully close an open valve, or to fully open a closed valve.

Despite the existence of these problems for generations of marine valves, no satisfactory solution has yet been proposed. Therefore, there exists a need in the art for a method and device to free up frozen valves and/or inaccessible valves in applications having limited space, and specifically in marine applications.

### SUMMARY OF THE INVENTION

The present invention is directed toward a method and device for freeing up frozen valves, particularly frozen valves that are disposed in tight locations, such as are commonly found in marine applications.

In accordance with one aspect of the invention, a valve assembly includes a valve body having a rotary valve member and a valve stem extending from the valve body. A handle, which has a proximal end and a distal end, is connected to the valve stem and extends therefrom. The handle is operable to rotate the valve member between an open position and a closed position. The handle distal end defines an opening, the opening being designed and intended to receive a ratchet handle.

In accordance with another aspect of the invention, a combination improved valve handle and valve handle extension is provided. The valve handle has a proximal end operable to rotatably drive a valve member and a distal end selectively engageable with the valve handle extension. The valve handle extension is a ratchet handle and the valve handle distal end defines an opening that receives a drive head of the ratchet handle.

In accordance with another aspect of the invention, a method and device are provided to make possible the full ninety-degree handle actuation necessary to open an inaccessible closed valve or to close an inaccessible open valve.

In accordance with a further aspect of the invention, a method for creating additional torque to free a frozen valve is provided. The valve includes a valve body receiving a rotary valve member, a valve stem extending from the rotary valve member and the valve body, and a valve handle connected to the valve stem at a proximal end thereof and having a distal end. The method includes providing an opening in the distal end of the valve handle, the opening being adapted to receive a drive head of a ratchet handle. The drive head of the ratchet handle is inserted into the valve handle opening, and the ratchet handle is placed in a position to effectively extend a length of the valve handle. Thereafter, force is applied to the ratchet handle to force the valve handle in a desired rotational direction.

### BRIEF DESCRIPTION OF THE DRAWINGS

These and further features of the invention will be apparent with reference to the following description and drawings, wherein:

FIG. 1 is a side elevational view of a valve incorporating a valve handle according to the present invention;

FIG. 2 is a side elevational view of a valve according to FIG. 1, with a handle extension device secured to the handle according to the present invention and the handle extension device aligned with the valve handle;

FIG. 3 is a side elevational view similar to FIG. 2, but showing the handle extension device in an angular orientations relative to a length of the handle; and,

FIG. 4 is a side elevational view showing the handle extension device in a storage position.

### DETAILED DESCRIPTION OF THE PREFERRED EMBODIMENT

It should be noted that in the detailed description which follows, identical components have the same reference numerals, regardless of whether they are shown in different embodiments of the present invention. It should also be noted that in order to clearly and concisely disclose the present invention, the drawings may not necessarily be to scale and certain features of the invention may be shown in somewhat schematic form.

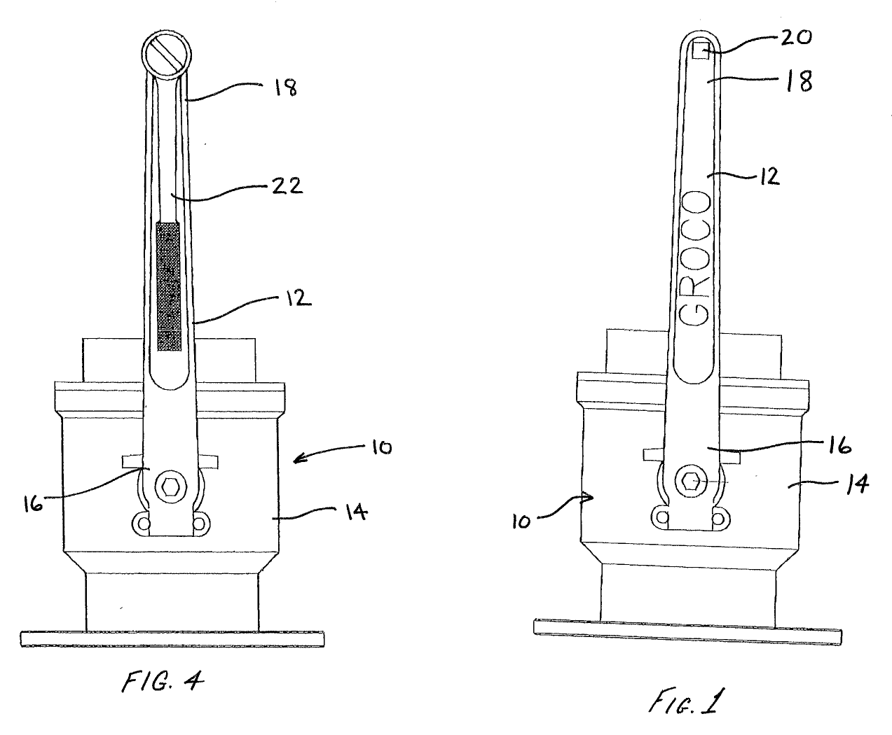

With reference to FIG. 1, a valve 10 incorporating a handle 12 according to the present invention is illustrated. The valve 10 includes a valve body 14 in which is disposed a rotary valve number. The valve member may take on any of the forms known in the art such as, for example, a ball valve, a butterfly valve, etc. Insofar as the present invention is not directed toward the valve member, and it being expected that one skilled in the art will be able to adapt the present invention for use in valves using any of the known or hereafter developed rotary valve members, the rotary valve member and operation of the valve will not be discussed in detail hereinafter.

The valve handle 12 has a proximal end 16 and a distal end 18. The proximal end 16 is affixed to a valve stem or other device for actuating the rotary valve member. The distal end 18 is ordinarily gripped by the user to turn the handle 12 to open and close the valve.

The distal end 18 has an opening 20 formed therein. The illustrated opening 20 is generally square in shape, however it is contemplated that other shapes, such as hexagonal, may also be used with satisfactory results. In any event, the handle opening 20 is shaped and dimensioned to receive a drive head of a ratchet handle 22. It is noted that the ratchet is conventional and well known in the art to include a clutch member that is adapted to selectively permit (or prevent) rotation of the ratchet handle 22 relative to the drive head. It is further noted that the drive head of the ratchet handle 22 may be inserted into the opening 20 from either side, as desired.

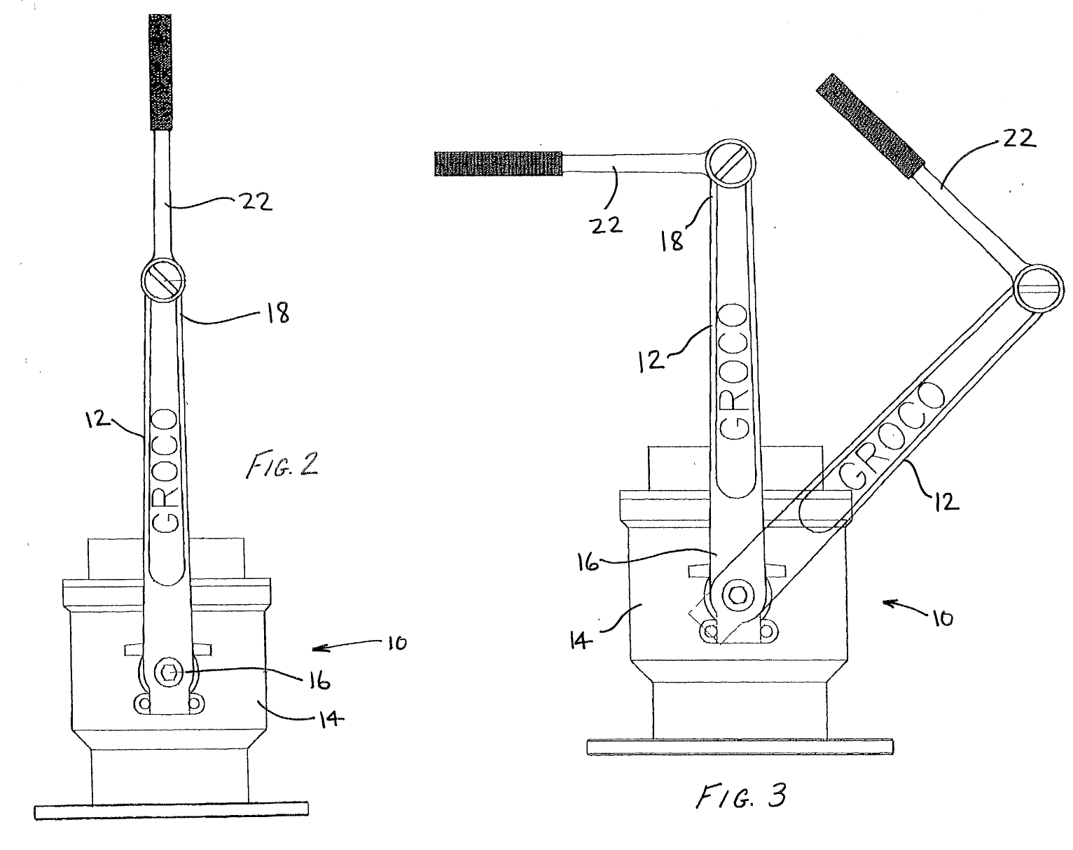

FIGS. 2-4 illustrate the ratchet handle 22 attached to the valve handle in various configurations or orientations. FIG. 2 shows the ratchet handle 22 in-line with a length of the valve handle 12. In this configuration a maximum additional mechanical advantage may be gained to assist in opening or closing the valve 10. Such additional mechanical advantage may be necessary to break free a frozen valve.

With conventional marine valves, a ninety-degree handle throw is required to move the valve from the fully closed position to the fully open position or from the fully open position to the fully closed position. Since the angular position of the ratchet handle 22 relative to the valve handle 12 is variable, the ratchet handle can be used to move the valve handle 12 through required arc without the ratchet handle 22 moving through a similar arc.

The valve 10 is ordinarily installed in locations wherein limited space for the handle 12 is available. Accordingly, the present invention is adapted to permit re-alignment or repositioning of the ratchet handle 22 by the user.

FIG. 3 illustrates a pair of positions of the valve handle 12 and ratchet handle 22 when the ratchet handle 22 is attached to the valve handle 12 at an angle to the length of the valve handle. In the illustrated example, the ratchet handle 22 is at about 90° relative to the valve handle 12. Naturally, the ratchet handle is fully adjustable relative to the valve handle. The user will ordinarily position the ratchet handle 22 at as small an angle as possible to the axis of the valve handle 12 to maintain a maximum mechanical advantage.

FIG. 4 shows the ratchet handle 22 in a storage position. In the storage position the ratchet handle is aligned with the valve handle 12, but is doubled-back on the valve handle so as to extend toward the proximal end 16 of the valve handle 12. It is believed that supplying a ratchet handle with each or several valves may be advantageous and desirable, especially when storage of the ratchet handle in a non-obtrusive position, as afforded by the present invention, is possible.

The present invention has been described herein with particularity, but it is noted that the scope of the invention is not limited thereto. Rather, the present invention is considered to be possible of numerous modifications, alterations, and combinations of parts and, therefore, is only defined by the claims appended hereto.

What is claimed is:

1. A valve assembly comprising:
a valve body having a rotary valve member and a valve stem extending from said valve body;
a handle having a proximal end and a distal end, and a longitudinal axis extending between said proximal and distal ends, said proximal end being connected to said valve stem and said handle being operable to rotate said valve member between an open position and a closed position;
the improvement comprising:
said handle distal end defining an opening that is adapted to receive a ratchet handle.

2. The valve assembly according to claim 1, wherein said opening is generally square.

3. The valve assembly according to claim 1, wherein said opening is generally hexagonal.

4. In combination, an improved valve handle and valve handle extension, said valve handle having a proximal end operable to rotatably drive a valve member and a distal end selectively engageable with said valve handle extension, wherein said valve handle extension is a ratchet handle and said valve handle distal end defines an opening that receives a drive head of said ratchet handle.

5. A method for creating additional torque to free a frozen valve, wherein said valve includes a valve body receiving a rotary valve member, a valve stem extending from said rotary valve member and said valve body, and a valve handle connected to said valve stem at a proximal end thereof and having a distal end, comprising the steps of:
providing an opening in said distal end of said valve handle, said opening being adapted to receive a drive head of a ratchet handle;
inserting the drive head of the ratchet handle into said valve handle opening;
positioning said ratchet handle in a position to effectively extend a length of said valve handle; and,
applying force to said ratchet handle to force said valve handle in a desired rotational direction.
